(19) United States
(12) Patent Application Publication
(10) Pub. No.: US 2026/0168790 A1
(43) Pub. Date: Jun. 18, 2026

(54) MULTIWAVELENGTH MEASUREMENTS FOR SCANNING OVERLAY METROLOGY

(71) Applicant: KLA Corporation, Milpitas, CA (US)

(72) Inventors: Alon Alexander Volfman, Migdal Haemek (IL); David Koprivica, Petah Tikva (RS); Itay Gdor, Tel-Aviv (IL); Iftach Galon, Migdal Haemek (IL); Yonatan Vaknin, Yoqneam Illit (IL); Vladimir Levinski, Migdal Haemek (IL); Yuval Lubashevsky, Haifa (IL); Daria Negri, Nesher (IL); Andrew V. Hill, Berkley, CA (US); Nadav Gutman, Zichron Ya'aqov (IL)

(21) Appl. No.: 18/982,949

(22) Filed: Dec. 16, 2024

(51) Int. Cl. G01B 11/27

(52) U.S. Cl. CPC G01B 11/272; G01B 2210/56

(57) ABSTRACT

A metrology system and method for imaging samples such as semiconductor devices having metrology targets for measuring overlay. In embodiments, the system includes an illumination source configured to generate a multiwavelength illumination beam, collection channels for collecting wavelength-selective collected light from the sample in accordance with a metrology recipe, and a controller configured to receive wavelength-selective datasets and determine at least one overlay measurement from the wavelength-selective datasets received.

### TECHNICAL FIELD

The present disclosure relates generally to overlay metrology and, more particularly, to systems and methods for obtaining multiwavelength measurements in overlay metrology.

### BACKGROUND

Overlay metrology generally refers to measurements of the relative alignment of layers on a sample such as, but not limited to, semiconductor devices. An overlay measurement, or a measurement of overlay error, typically refers to a measurement of the misalignment of fabricated features on two or more sample layers. In a general sense, proper alignment of fabricated features on multiple sample layers is necessary for proper functioning of the device.

Demands to decrease feature size and increase feature density are resulting in correspondingly increased demand for accurate and efficient overlay metrology systems. Metrology systems typically generate metrology data associated with a sample by measuring or otherwise inspecting overlay metrology targets distributed across the sample. Overlay metrology targets are typically designed to provide diagnostic information regarding the alignment of multiple layers of a sample by characterizing an overlay target having target features located on sample layers of interest. Further, the overlay alignment of the multiple layers is typically determined by aggregating overlay measurements of multiple overlay targets at various locations across the sample.

Scanning metrology is a type of metrology in which a moving metrology target (e.g., Moiré target) is scanned by an illumination beam along at least one target direction, and the intensity of the diffracted light is captured by one or more detectors. In traditional scanning metrology, intensity measurements are obtained in a single scan using a single wavelength illumination beam considering time and efficiency constraints do not allow for sequential measurements at different wavelengths. As such, accuracy in traditional scanning metrology systems is highly wavelength dependent.

Therefore, to increase accuracy measurements without decreasing efficiency, what is needed is a system for obtaining simultaneous multiwavelength measurements in a single scan.

### SUMMARY

According to a first aspect, the present disclosure is directed to overlay metrology system including an illumination sub-system, a collection sub-system, and a controller. In embodiments, the illumination sub-system includes an illumination source configured to generate a multiwavelength illumination beam, and one or more illumination optics configured to direct the multiwavelength illumination beam to an overlay target on a sample as the sample is scanned relative to the multiwavelength illumination beam along a scan direction when implementing a metrology recipe. In embodiments, the collection sub-system includes two or more collection channels configured to collect two or more wavelength-selective datasets of collected light from the sample, each collection channel including photodetectors located in a pupil plane at locations to capture overlap between diffraction orders when implementing the metrology recipe. In embodiments, the controller is communicatively coupled to the photodetectors of the two or more collection channels, and includes one or more processors configured to execute program instructions causing the one or more processors to receive the two or more wavelength-selective datasets from the photodetectors as the overlay target is scanned in accordance with the metrology recipe, and determine at least one overlay measurement from the two or more wavelength-selective datasets received.

According to another aspect, the present disclosure is directed to an overlay metrology system including an illumination sub-system, a collection sub-system, and a controller. In embodiments, the illumination sub-system includes one or more illumination channels for illuminating an overlay target on a sample with a multiwavelength illumination beam as the sample is scanned along a stage-scan direction by a translation stage when implementing a metrology recipe. In embodiments, the collection sub-system includes one or more collection channels associated with the one or more illumination channels, wherein each collection channel comprises a first photodetector located in a pupil plane at a first location and a second photodetector located in the pupil plane at a second location. In embodiments, the controller is communicatively coupled to the photodetectors and includes one or more processors configured to execute program instructions causing the one or more processors to receive two or more wavelength-selective datasets from the photodetectors as the overlay target is scanned in accordance with the metrology recipe, and determine at least one overlay measurement from the two or more wavelength-selective datasets received.

According to a further aspect, the present disclosure is directed to an overlay metrology method including providing an overlay metrology tool including an illumination sub-system including an illumination source configured to generate a multiwavelength illumination beam, and one or more illumination optics configured to direct the multiwavelength illumination beam to an overlay target on a sample as the sample is scanned relative to the multiwavelength illumination beam along a scan direction when implementing a metrology recipe, and a collection sub-system including two or more collection channels configured to receive multiwavelength collected light from the sample and including at least one wavelength separator configured to separate the multiwavelength collected light when implementing the metrology recipe. The method further includes separating by the at least one wavelength separator two or more preselected wavelengths of the multiwavelength collected light, collecting by the two or more collection channels the two or more preselected wavelengths separated by the at least one wavelength separator, receiving by a controller wavelength-selective datasets of the overlay target as the overlay target is scanned, and determining by the controller at least one overlay measurement from the distinct wavelength-selective datasets received.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the disclosure may be better understood by those skilled in the art by reference to the accompanying figures in which:

FIG. 1 is a schematic diagram of a system for performing overlay metrology, in accordance with one or more embodiments of the present disclosure;

FIG. 2 is a schematic diagram illustrating a metrology tool including a plurality of collection channels and associated wavelength-selective beamsplitters, in accordance with one or more embodiments of the present disclosure;

FIG. 3 is a schematic diagram illustrating an array including sensors and color filters, in accordance with one or more embodiments of the present disclosure;

FIG. 4 is a schematic diagram illustrating a metrology tool including at least one array of sensors and color filters, in accordance with one or more embodiments of the present disclosure;

FIG. 5 is a graph illustrating per filter overlay measurements using the array of sensors and color filters, in accordance with one or embodiments of the present disclosure; and

FIG. 6 is a flow diagram illustrating a method for performing overlay metrology, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

For the purposes of the present disclosure, the term “scatterometry metrology” is used to broadly encompass the terms “scatterometry-based metrology” and “diffraction-based metrology” in which a sample having periodic features on one or more sample layers is illuminated with an illumination beam having a limited angular extent and one or more distinct diffraction orders are collected for the measurement. Further, the term “scanning metrology” is used to describe metrology measurements generated when a sample is in motion relative to illumination used for a measurement. In a general sense, scanning metrology may be implemented by moving the sample, the illumination beam, or both.

Some embodiments of the present disclosure are directed to providing recipes for configuring an overlay metrology tool. An overlay metrology tool is typically configurable according to a recipe including a set of parameters for controlling various aspects of an overlay measurement such as, but not limited to, the illumination of a sample, the collection of light from the sample, or the position of the sample during a measurement. In this way, the overlay metrology tool may be configured to provide a selected type of measurement for one or more overlay target designs of interest. For example, a metrology recipe may include illumination parameters such as, but not limited to, the number of illumination beams, illumination wavelength, an illumination pupil distribution (e.g., a distribution of illumination angles and associated intensities of illumination at those angles), a polarization of incident illumination, or a spatial distribution of illumination.

By way of another example, a metrology recipe may include collection parameters such as, but not limited to, a collection pupil distribution (e.g., a desired distribution of angular light from the sample to be used for a measurement and associated filtered intensities at those angles), collection field stop settings to select portions of the sample of interest, polarization of collected light, wavelength filters, positions of one or more detectors (e.g., photodetectors) or parameters for controlling the one or more detectors. By way of a further example, a metrology recipe may include various parameters associated with the sample position during a measurement such as, but not limited to, a sample height, a sample orientation, whether a sample is static during a measurement, or whether a sample is in motion during a measurement (along with associated parameters describing the speed, scan pattern, or the like).

Embodiments of the present disclosure are directed to scanning scatterometry overlay using a multiwavelength illumination beam to illuminate overlay metrology targets, for instance gratings that include two or more diffraction gratings. In some embodiments, the gratings may be arranged orthogonal to a scan direction or along the scan direction. In some embodiments, the properties of the gratings (e.g., pitches of the constituent gratings, or the like) and the measurement conditions (e.g., illumination wavelength, illumination incidence angle, collection angle, or the like) are arranged or otherwise selected (e.g., using a metrology recipe) to provide a selected distribution of diffraction and/or combined diffraction orders.

It is further contemplated herein that the systems and methods disclosed herein may provide sensitive overlay metrology at a high throughput. For example, the non-imaging configuration enables the use of fast photodetectors suitable for fast scan speeds. As a non-limiting example, photodetectors having a bandwidth of 1 GHz may enable scan speeds of approximately 10 centimeters per second on targets having a pitch of 1 micrometer.

In embodiments, gratings may generally be formed as portions of overlay targets and may generally be located anywhere on the sample. Further, a cell may include one or more gratings. An overlay measurement may then be based on any combination of measurements of the various cells of the overlay target. For example, at least one cell of an overlay target may be designed with different intended offsets (e.g., gratings in the various layers of the sample that are intentionally misaligned with known offset values), which may improve the accuracy and/or sensitivity of the measurement.

In embodiments, scanning overlay metrology according to the present disclosure may be based on time-varying interference signals from structures (e.g., Moiré structures) in a collection pupil plane. It is contemplated herein that measurement conditions leading to overlapping diffraction orders from constituent gratings may lead to interference. Such interference signals may include information associated with asymmetries in the target structure such as, but not limited to, overlay between the top and bottom gratings. It is further contemplated herein that scanning the structure relative to an illumination beam (or vice versa) may provide characterization of the position-dependent overlay of the structure and may thus enable the determination of asymmetries such as, but not limited to, overlay.

It is contemplated herein that scatterometry overlay metrology as disclosed herein may provide numerous benefits. For example, the systems and methods disclosed herein may obtain overlay measurements in a single scan wherein the sample is illuminated with several wavelengths simultaneously and the wavelengths are separated according to a collection scheme to measure per wavelength overlay. With this method, different measurements for different wavelengths can be obtained in a single scan for better measurement accuracy and efficiency. Further, the systems and methods disclosed herein may overcome difficulties in measuring each layer with its ‘ideal’ wavelength since the laser scanning method performance is not dependent on any one wavelength of light used. In this regard, a broad wavelength range may be used. In addition, the systems and methods disclosed herein may improve target accuracy by allowing measurement of extremely small printed targets that are closer to the size of the actual device.

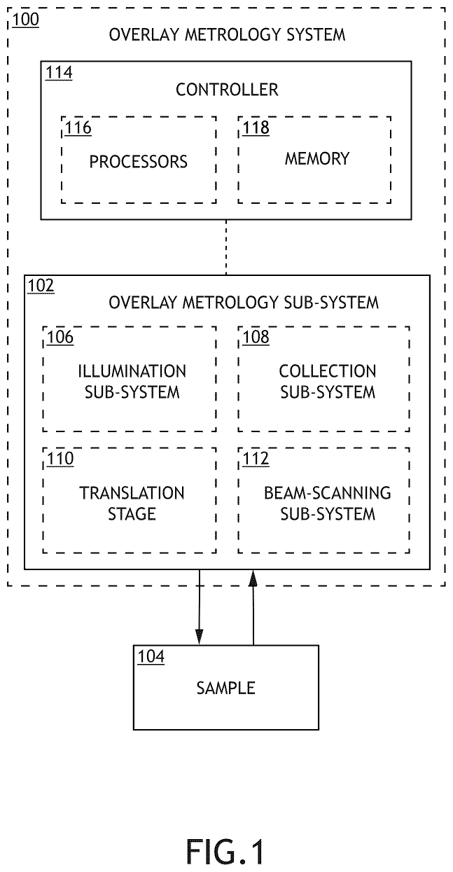

FIG. 1 illustrates a system for performing scanning overlay metrology. While FIG. 1 shows various components grouped as part of sub-systems of the overall system, it is understood that the various components may be grouped as part of separate systems or sub-systems that operate together to perform as described in detail below. For example, certain components for generating, collecting, and splitting light may be grouped in one sub-system, whereas other components for handling the imaging light and generating images may be grouped into another separate sub-system.

In embodiments, the overlay metrology system 100 includes an overlay metrology tool 102 configured to perform scatterometry overlay measurements of a sample 104. In embodiments, the overlay metrology tool 102 includes an illumination subsystem 106 configured to generate illumination in the form of one or more illumination beams to illuminate a sample 104, and a collection sub-system 108 configured to collect light from the illuminated sample 104. In embodiments, the overlay metrology tool 102 further includes a translation stage 110 configured to scan the sample 104 through a measurement field of view of the overlay metrology tool 102 during a measurement to implement scanning metrology. In embodiments, the overlay metrology tool 102 includes a beam-scanning sub-system 112 configured to modify or otherwise control a position of at least one illumination beam on the sample 104. For example, the beam-scanning subsystem 112 may scan an illumination beam in a direction orthogonal to a scan direction (e.g., a direction in which the translation stage 110 scans the sample 104) during a measurement.

In embodiments, the overlay metrology system 100 further includes a controller 114 communicatively coupled to the overlay metrology tool 102. The controller 114 may include one or more processors 116 and a memory device 118, or memory. For example, the one or more processors 116 may be configured to execute a set of program instructions maintained in the memory device 118 (e.g., the set of program instructions causing the one or more processors to receive, determine, etc.). The controller 114 may execute any of various processing steps associated with overlay metrology. For example, the controller 114 may be configured to generate control signals to direct or otherwise control the overlay metrology tool 102, or any components thereof. For instance, the controller 114 may be configured to direct the translation stage 110 to translate the sample 104 along one or more measurement paths (e.g., stage-scan direction), or swaths, to scan one or more overlay targets through a measurement field of view of the overlay metrology tool 102 and/or direct the beam-scanning sub-system 112 to position or scan one or more modified illumination beams on the sample 104. By way of another example, the controller 114 may be configured to generate corrections for one or more additional fabrication tools as feedback and/or feed-forward control of the one or more additional fabrication tools based on overlay measurements from the overlay metrology tool 102.

In embodiments, the controller 114 receives outputs (e.g., wavelength-selected datasets) from photodetectors according to a first embodiment, or from a diode array according to a second embodiment. In embodiments, the controller 114 determines an overlay measurement associated with each separate wavelength-selected dataset, which may be useful as raw data, to determine weighted averages, for comparison, etc. Further, the controller 114 may calibrate or otherwise modify the overlay measurement based on known, assumed, or measured features of the sample.

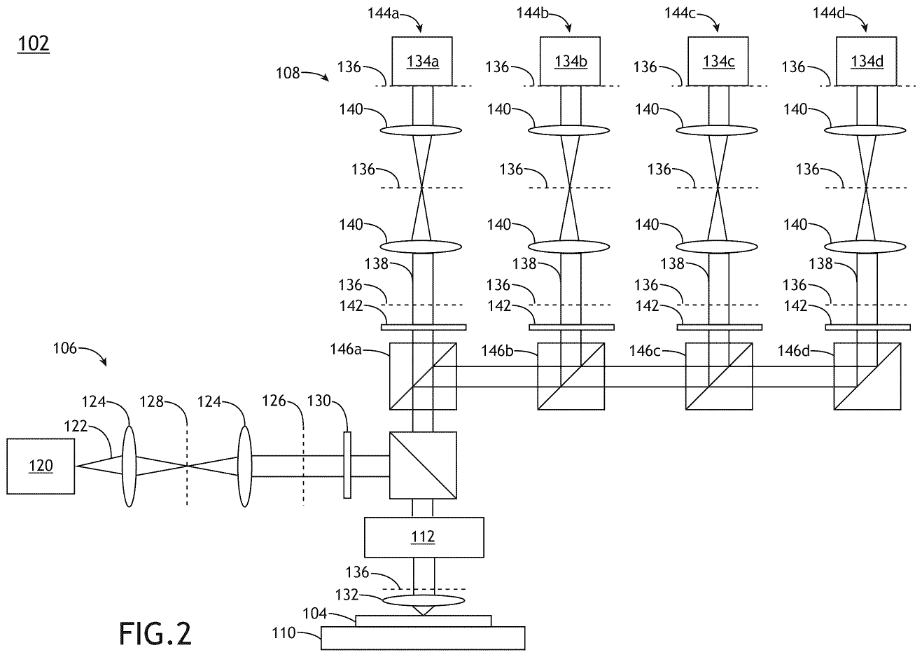

FIG. 2 illustrates an embodiment of a metrology tool 102 for obtaining multiwavelength metrology measurements. In embodiments, the illumination sub-system 106 includes an illumination source 120 configured to generate at least one multiwavelength illumination beam 122. The illumination from the illumination source 120 includes two or more selected wavelengths of light including, but not limited to, ultraviolet (UV) radiation, visible radiation, and infrared (IR) radiation. The illumination source 120 may include any type of illumination source suitable for providing at least one illumination beam 122. In some embodiments, the illumination source 120 is a laser source. For example, the illumination source 120 may include, but is not limited to, two or more narrowband laser sources, a broadband laser source, a supercontinuum laser source, a white light laser source, or the like. In this regard, the illumination source 120 may provide an illumination beam 122 having high coherence (e.g., high spatial coherence and/or temporal coherence). In some embodiments, the illumination source 120 includes a laser-sustained plasma (LSP) source. For example, the illumination source 120 may include, but is not limited to, an LSP lamp, an LSP bulb, or an LSP chamber suitable for containing one or more elements that, when excited by a laser source into a plasma state, may emit an illumination beam.

In embodiments, the illumination sub-system 106 includes one or more optical components suitable for modifying and/or conditioning the illumination beam 122 as well as directing the illumination beam 122 to the sample 104 positioned on the translation stage 110. For example, the illumination sub-system 106 may include one or more illumination lenses 124 (e.g., to collimate the illumination beam 122, to relay an illumination pupil plane 126 and/or an illumination field plane 128, or the like). In some embodiments, the illumination sub-system 106 includes one or more illumination control optics 130 to shape or otherwise control the illumination beam 122. For example, the illumination control optics 130 may include, but are not limited to, one or more apodizers, one or more field stops, one or more pupil stops, one or more polarizers, one or more filters, one or more beam splitters, one or more diffusers, one or more homogenizers, one or more beam shapers, or one or more mirrors (e.g., static mirrors, translatable mirrors, scanning mirrors, or the like).

In embodiments, the overlay metrology tool 102 includes an objective lens 132 configured to focus the illumination beam 122 onto the sample 104 (e.g., an overlay target with overlay target elements located on two or more layers of the sample 104). In embodiments, the illumination sub-system 106 illuminates the sample 104 with at least one illumination beam 122. Further, the at least one illumination beam 122 may be, but is not required to be, incident on different portions of the sample 104 (e.g., different cells of an overlay target) within a measurement field of view (e.g., a field of view of the objective lens 132). It is contemplated herein that the at least one illumination beam 122 may be generated using a variety of techniques. In some embodiments, the illumination subsystem 106 includes at least one aperture at an illumination field plane 128. In some embodiments, the illumination sub-system 106 may include at least one beamsplitters to split illumination from the illumination source 120 into two or more illumination beams 122. In some embodiments, at least one illumination source 120 generates the at least one illumination beam 122 directly. In a general sense, the at least one illumination beam 122 may be considered to be a part of a different illumination channel regardless of the technique in which the at least one illumination beam 122 is generated.

In embodiments, the collection sub-system 108 includes two or more photodetectors 134a-d located at a collection pupil plane 136 configured to capture light from the sample 104 (e.g., collected light 138). The collection sub-system 108 may include one or more optical elements suitable for modifying and/or conditioning the collected light 138 from the sample 104. In some embodiments, the collection sub-system 108 includes one or more collection lenses 140 (e.g., to collimate the illumination beam 122, to relay pupil and/or field planes, or the like), which may include, but are not required to include, the objective lens 132. In some embodiments, the collection sub-system 108 includes one or more collection control optics 142 to shape or otherwise control the collected light 138. For example, the collection control optics 142 may include, but are not limited to, one or more field stops, one or more pupil stops, one or more polarizers, one or more filters, one or more beam splitters, one or more diffusers, one or more homogenizers, one or more apodizers, one or more beam shapers, or one or more mirrors (e.g., static mirrors, translatable mirrors, scanning mirrors, or the like).

In embodiments, the collection sub-system 108 includes one or more collection channels 144a-d, each including at least one photodetector 134a-d, and each collection channel 144a-d corresponding to a different predefined wavelength or wavelength range. For example, the overlay metrology tool 102 may include two or more wavelength-selective dichroic beamsplitters (DBS) 146a-d configured to split the collected light 138 into the collection channels 144a-d according to different wavelengths. For example, the DBS 146a of the first collection channel 144a may have a first dichroic optical coating correspoding to a first preselected wavelength of the collected light 138, the DBS 146b of the second collection channel 144b may have a second dichroic optical coating correspoding to a second preselected wavelength of the collected light 138, the DBS 146c associated with the third collection channel 144c may have a third dichroic optical coating correspoding to a third distinct preselected wavelength of the collected light 138, the fourth DBS 146d associated with the fourth collection channel 144d may have a fourth dichroic optical coating correspoding to a fourth distinct preselected wavelength of the collected light 138, etc., wherein each of the first, second, third, fourth, etc. distinct wavelengths are different wavelengths. In an alternative configuration, the collected light may be split using a dichroic mirrored prism including various dichroic optic coatings to the divide the collected light into a number of spectrally distinct output beams directed to corresponding collection channels 144a-d. In embodimens, the collected light associated with the various collection channels 144a-d may be collected simultaneously or sequentially.

In use, a sample 104 is illuminated with more than one wavelength of light and each collection channel 144a-d is configured to collect a different wavelength such that separate preselected wavelengths can be collected to measure per wavelength overlay. For example, certain wavelengths may provide more accurate overlay measurements as compared to other wavelengths, and the raw data collected from the different collection channels 144a-d may be analyzed, compared, averaged, etc. In embodiments, each wavelength may capture (or more accurately capture) a different inaccuracy response, error source, etc., such that a statistical method may be employed to eliminate errors. In embodiments, more or fewer collection channels 144a-d may be included depending on the number of separate wavelengths. In embodiments, duplicate collection channels may be included for one or more wavelengths for redundancy.

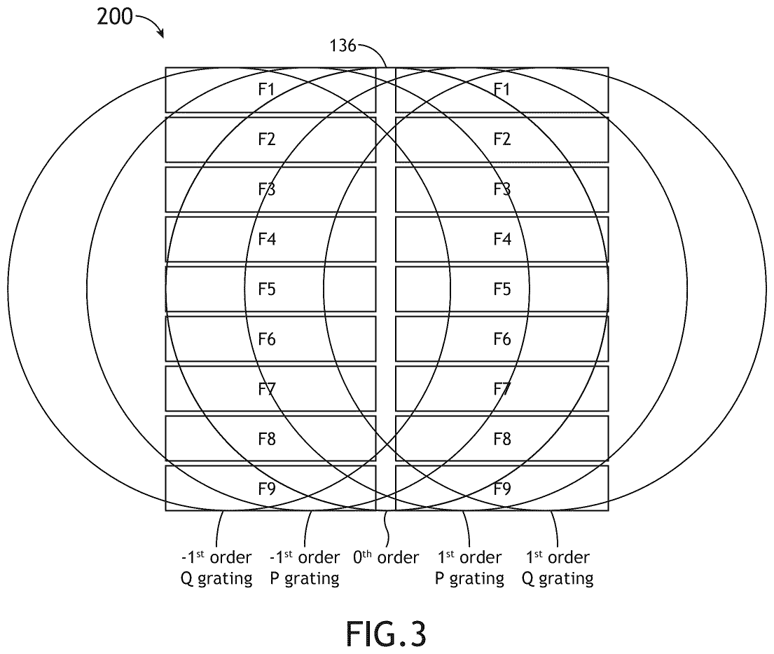

FIG. 3 illustrates an alternative embodiment for multiwavelength signal capture using a sensor and color filter array 200 configured to be positioned in the pupil plane 136 of the collected light to separate the collected light into wavelengths (e.g., ranges of wavelengths) which fall on multiple sensors to generate a simultaneous set of signals. In embodiments, the sensor and color filter array 200 includes a plurality of separate sensors (e.g., a photo diode, a complementary metal-oxide semiconductor (CMOS), a charge-coupled device (CCD), etc.) covered with separate color filters F1-F9 such that, in use, a portion of the wavelength spectrum passes through each color filter F1-F9 onto the sensors and the sensors create signals proportional to the total light energy passing through each color filter F1-F9. In embodiments, the color filters may be fixed color filters, color-selective color filters, or electrically controlled color filters.

In embodiments, the number and arrangement of color filter covered sensors F1-F9 may vary depending on the separate wavelengths to be filtered, as well as the number of sensors to the number of color filters. In other words, the array is variable in terms of the number of sensors and number of filters. As such, the sensor and color filter array 200 including 18 filters as shown is not limited thereto. For example, each color filter covered sensor F1-F9 may correspond to a different wavelength to allow light of that wavelength to be transmitted to the sensor beyond the color filter to produce a signal. In a non-limiting example, separate color filter covered sensors may correspond to violet (380-450 nm), deep blue (450-484 nm), light blue (484-500 nm), green (500-565 nm), yellow (565-590 nm), orange (590-625 nm) and red (625-700 nm), white (entire frequency spectrum), etc.

The sensor and color filter array 200 may be positioned in a pupil plane in the collection sub-system 108. In embodiments, the illumination sub-system 106 may illuminate the sample 104 with one or more illumination beams 122 at normal incidence as illustrated by the 0^{th} order. In embodiments, the illumination sub-system 106 may illuminate the sample with a limited range of incidence angles. In this regard, the sample 104 may diffract the one or more illumination beams 122 into discrete diffraction orders, for example, the −1^{st} order and +1^{st} order in the case of two gratings P and Q, where portions overlap in overlapping regions corresponding to positions on the sensor and color filter array 200. The distribution of diffracted orders may vary depending on the structure of the sample 104.

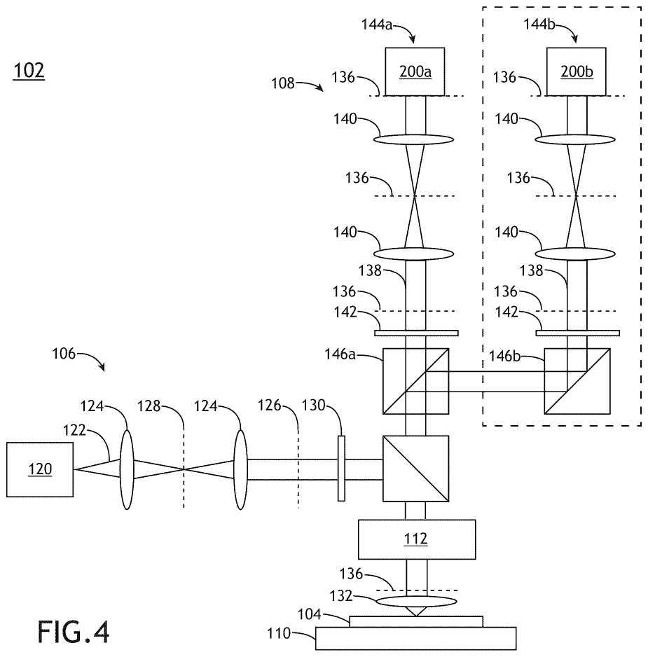

FIG. 4 illustrates a variation of the metrology tool 102 including one or more sensor and color filter arrays 200a, b positioned in the pupil plane 136 of the collected light 138. In embodiments, the metrology tool 102 may include a single collection channel 144a including a single sensor and color filter array 200a, or the metrology tool 102 may include multiple collection channels 144a, b each including a sensor and color filter array 200a, b, wherein the senor and color filter arrays 200a, b may be the same for redundancy or different to collect different wavelength data. For example, the overlay metrology tool 102 may include one or more beamsplitters 146a, b configured to split the collected light 138 into the collection channels 144a, b.

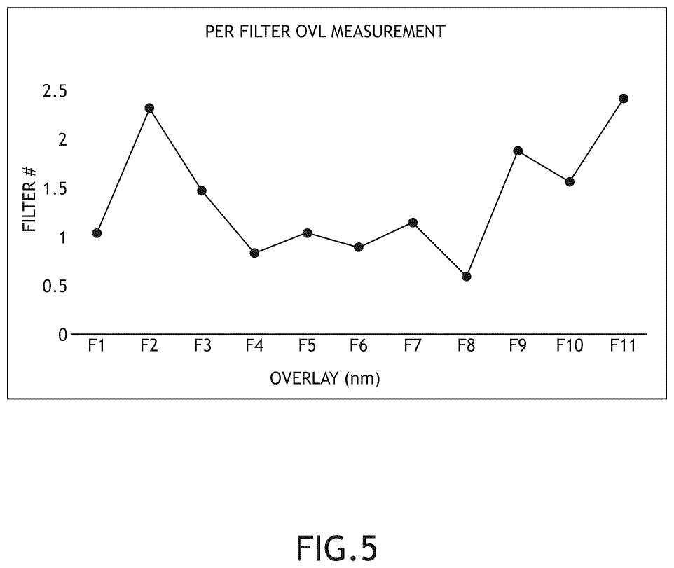

FIG. 5 graphically illustrates a non-limiting example of overlay measurements obtained using a sensor and color filter array 200 according to the present disclosure. As shown, a plurality of filters F1-F11 associated with one or more sensors obtain varying per wavelength overlay measurements that may be used, for example, to calculate a final overlay using statistical methods.

In embodiments, the multiwavelength systems and methods disclosed herein may be utilized in scanning overlay metrology systems, for instance those generally discussed in U.S. Pat. No. 11,300,405 issued on Apr. 12, 2022; U.S. Pat. No. 11,378,394, issued on Jul. 5, 2022; U.S. patent application Ser. No. 17/708,958, filed on Mar. 30, 2022; U.S. patent application Ser. No. 17/709,200, filed Mar. 30, 2022; U.S. patent application Ser. No. 17/709,104, filed on Mar. 30, 2022; U.S. patent application Ser. No. 18/099,798, filed Jan. 20, 2023; and U.S. patent application Ser. No. 18/110,746, filed on Feb. 16, 2023, describing scanning overlay metrology systems in which photodiodes capture time-varying signals during a scan and overly is determined based on the time-varying signals from opposing diodes. In such systems, the filter array may include pairs of matched filters as shown in FIG. 3, for example, with one set for positive diffraction orders and the other set for negative diffraction orders.

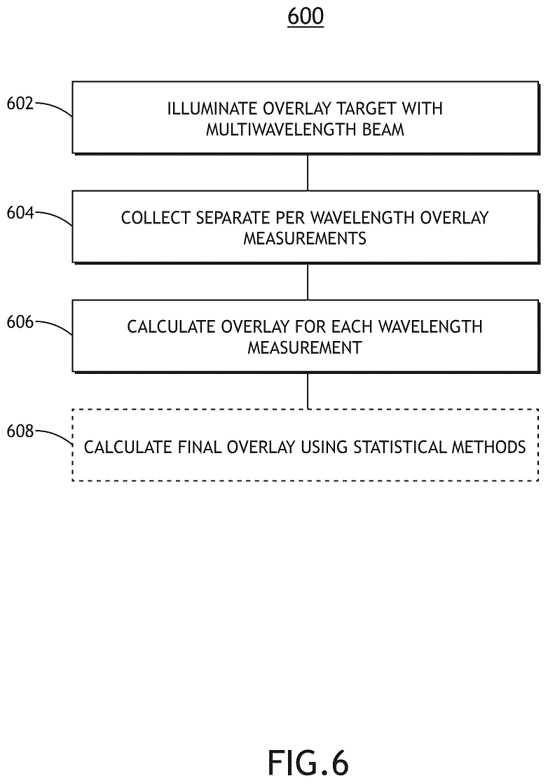

FIG. 6 is a flow diagram illustrating steps performed in a method 600 for obtaining separate per wavelength overlay measurements. It is understood that the embodiments and enabling technologies described previously herein in the context of the overlay metrology system 100 should be interpreted to extend to the method 600. It is further noted, however, that the method 600 is not limited to the architecture of the overlay metrology system 100.

In a step 602, an overlay target is illuminated with a multiwavelength illumination beam. For example, the overlay target on a sample is illuminated as the sample is scanned with respect to the multiwavelength illumination. In a step 604, per wavelengths signals are collected by separate collection devices and along one or more collection channels. For example, the separate wavelengths may be collected using separate collection channels each including a different dichroic beamsplitter or one or more channels including diode array with color filters. In a step 606, overlay may be calculated for each separate wavelength according to a predetermined calculation method. In an optional step 608, a final overlay may be calculated using statistical methods using the per wavelength results (e.g., weighted average).

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected” or “coupled” to each other to achieve the desired functionality, and any two components capable of being so associated can also be viewed as being “couplable” to each other to achieve the desired functionality. Specific examples of couplable include but are not limited to physically interactable and/or physically interacting components and/or wirelessly interactable and/or wirelessly interacting components and/or logically interactable and/or logically interacting components.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. An overlay metrology system comprising:
an illumination sub-system comprising:
an illumination source configured to generate a multiwavelength illumination beam; and
one or more illumination optics configured to direct the multiwavelength illumination beam to an overlay target on a sample as the sample is scanned relative to the multiwavelength illumination beam along a scan direction when implementing a metrology recipe;
a collection sub-system comprising:
two or more collection channels configured to collect two or more wavelength-selective datasets of collected light from the sample, each collection channel including photodetectors located in a pupil plane for capturing overlap between diffraction orders when implementing the metrology recipe; and
a controller communicatively coupled to the photodetectors of the two or more collection channels, the controller including one or more processors configured to execute program instructions causing the one or more processors to:
receive the two or more wavelength-selective datasets from the photodetectors as the overlay target is scanned in accordance with the metrology recipe; and
determine at least one overlay measurement from the two or more wavelength-selective datasets received.

2. The overlay metrology system of claim 1, wherein each collection channel is associated with a wavelength-selective beamsplitter configured to separate a preselected wavelength of collected light from the sample.

3. The overlay metrology system of claim 2, wherein each wavelength-selective beamsplitter is a dichroic beamsplitter.

4. The overlay metrology system of claim 2, wherein the preselected wavelengths of collected light are collected on the two or more collection channels simultaneously.

5. The overlay metrology system of claim 2, wherein the preselected wavelengths of collected light are collected on the two or more collection channels sequentially.

6. The overlay metrology system of claim 1, wherein the controller is configured to receive time-varying interference signals from the photodetectors as the overlay target is scanned in accordance with the metrology recipe.

7. The overlay metrology system of claim 1, wherein the controller is configured to calculate an overlay measurement of the overlay target for each of the wavelength-selective datasets received and calculate a final overlay measurement from the calculated overlay measurements.

8. The overlay metrology system of claim 1, wherein each of the photodetectors includes an array of sensors and color filters configured to separate the collected light from the sample into wavelength-selective signals corresponding to the wavelength-selective datasets.

9. The overlay metrology system of claim 8, wherein the array of sensors and color filters includes a plurality of color-selective filters positioned over a plurality of separate sensors.

10. The overlay metrology system of claim 8, wherein each color filter is a fixed color filter or an electrically controlled filter.

11. The overlay metrology system of claim 8, wherein the array of sensors and color filters includes two or more color-selective filters configured to filter two or more preselected wavelengths of collected light.

12. The overlay metrology system of claim 1, wherein each of the photodetectors includes colored filters positioned over a complementary metal-oxide semiconductor sensor or a charge-coupled diode sensor.

13. An overlay metrology system comprising:
an illumination sub-system comprising:
one or more illumination channels for illuminating an overlay target on a sample with a multiwavelength illumination beam as the sample is scanned along a stage-scan direction by a translation stage when implementing a metrology recipe:
a collection sub-system comprising:
one or more collection channels associated with the one or more illumination channels, wherein each collection channel comprises a first photodetector located in a pupil plane at a first location and a second photodetector located in the pupil plane at a second location; and
a controller communicatively coupled to the photodetectors, the controller including one or more processors configured to execute program instructions causing the one or more processors to:
receive two or more wavelength-selective datasets from the photodetectors as the overlay target is scanned in accordance with the metrology recipe; and
determine at least one overlay measurement from the two or more wavelength-selective datasets received.

14. The overlay metrology system of claim 13, wherein each collection channel is associated with a wavelength-selective beamsplitter configured to separate a preselected wavelength of collected light from the sample.

15. The overlay metrology system of claim 14, wherein the preselected wavelength of collected light from each collection channel are collected on the collection channels simultaneously.

16. The overlay metrology system of claim 14, wherein the preselected wavelength of collected light from each collection channel are collected on the collection channels sequentially.

17. The overlay metrology system of claim 13, wherein the controller is configured to receive time-varying interference signals from the first and second photodetectors as the overlay target is scanned in accordance with the metrology recipe.

18. The overlay metrology system of claim 13, wherein the controller is configured to calculate an overlay measurement of the overlay target for each of the wavelength-selective datasets received and calculate a final overlay measurement from the calculated overlay measurements.

19. The overlay metrology system of claim 13, wherein each of the first and second photodetectors includes an array of sensors and color filters configured to separate light from the sample into wavelength-selective signals corresponding to the wavelength-selective datasets.

20. The overlay metrology system of claim 19, wherein the array of sensors and color filters includes a plurality of color-selective filters positioned over a plurality of separate sensors.

21. The overlay metrology system of claim 19, wherein each color filter is a fixed color filter or an electrically controlled filter.

22. An overlay metrology method comprising, the method comprising:
providing an overlay metrology tool comprising:
an illumination sub-system comprising an illumination source configured to generate a multiwavelength illumination beam, and one or more illumination optics configured to direct the multiwavelength illumination beam to an overlay target on a sample as the sample is scanned relative to the multiwavelength illumination beam along a scan direction when implementing a metrology recipe; and
a collection sub-system comprising two or more collection channels configured to receive multiwavelength collected light from the sample and including at least one wavelength separator configured to separate the multiwavelength collected light when implementing the metrology recipe;
separating, by the at least one wavelength separator, two or more preselected wavelengths of the multiwavelength collected light;
collecting, by the two or more collection channels, the two or more preselected wavelengths separated by the at least one wavelength separator;
receiving, by a controller, wavelength-selective datasets of the overlay target as the overlay target is scanned; and
determining, by the controller, at least one overlay measurement from the wavelength-selective datasets received.

23. The method according to claim 22, wherein the at least one separate comprises at least one wavelength-selective beamsplitter configured to separate a preselected wavelength of collected light from the sample, and two or more photodetectors located in a pupil plane to capture the preselected wavelength of collected light when implementing the metrology recipe.

24. The method according to claim 22, wherein the preselected wavelengths of collected light are collected on the two or more collection channels simultaneously or sequentially.

25. The method according to claim 22, wherein the at least one separator comprises an array of sensors and color filters configured to separate the collected light from the sample into wavelength-selective signals corresponding to the wavelength-selective datasets.

26. The method according to claim 22, the method further comprising, by the controller, calculating an overlay measurement of the overlay target from the wavelength-selective datasets and calculating a final overlay measurement from the calculated overlay measurements.
